(19) United States
(12) Patent Application Publication
(10) Pub. No.: US 2024/0392103 A1
(43) Pub. Date: Nov. 28, 2024

(54) CO2-TRAPPING BITUMINOUS COMPOSITIONS MODIFIED BY INCORPORATION OF ALKALI METAL HYDROXIDE, ASSOCIATED METHODS AND USES

(71) Applicant: TOTALENERGIES ONETECH, Courbevoie (FR)

(72) Inventor: Jeanne ZHU, Courbevoie (FR)

(73) Assignee: TOTALENERGIES ONETECH, Courbevoie (FR)

(21) Appl. No.: 18/699,340

(22) PCT Filed: Oct. 6, 2022
(86) PCT No.: PCT/FR2022/051884

§ 371 Date: Apr. 8, 2024

(30) Foreign Application Priority Data
Oct. 8, 2021 (FR) FR2110676

(51) Int. Cl. C08K 3/22; B01D 53/62; B01D 53/80; C08L 95/00

(52) U.S. Cl. CPC C08K 3/22; B01D 53/62; B01D 53/80; C08L 95/00; B01D 2251/304; B01D 2251/604; B01D 2257/504; C08L 2555/50

(57) ABSTRACT

The present invention concerns a bituminous composition comprising a bitumen base modified by the incorporation of an alkali hydroxide, characterized in that CO₂ is trapped in said bituminous composition and represents from 0.5 to 5% by mass, preferably from 0.5 to 4% by mass, and preferentially from 0.5 to 3% by mass, even more preferably from 0.5 to 2% or from 0.5 to 1.5% or from 0.7 to 2% by mass of the mass of the bitumen base and the mass of the bituminous composition is stable at 25° C. and under 1013.25 hPa, over a period Ps of at least 10 hours, preferably at least 15 hours. The invention also concerns a method for the preparation of such compositions and their uses, in particular for the manufacture of mixes or asphalts.

### TECHNICAL FIELD

The present invention concerns the technical field of bitumens. More precisely, it concerns bituminous compositions that allow CO₂ to be trapped, and, consequently, offer the possibility of reducing the quantities of CO₂ emitted into the atmosphere. The invention also concerns methods for preparing such compositions, as well as their uses in the roadway and industrial fields.

### PRIOR ART

CO₂ is a greenhouse gas. Thus, the emission of CO₂ into the atmosphere contributes to global warming. To support sustainable development and reduce global warming, solutions are being sought to reduce the quantity of CO₂ released into the atmosphere. Means for capturing the CO₂ produced by various human activities are therefore of great interest.

The applicant has attempted to trap CO₂ in bituminous compositions, but the tests carried out in the examples show that CO₂ tends to be released after trapping in the bitumen, and that there is a real challenge in being able to stabilize a portion of the CO₂ that can be stored in bitumen, so that it can at least be partially stored in the bitumen for the long term.

In this context, the applicant proposes novel bituminous compositions making it possible to store CO₂ sustainably, methods for obtaining such compositions and their use in the roadway and industrial fields.

### DISCLOSURE OF THE INVENTION

The invention relates to a bituminous composition comprising a bitumen base modified by the incorporation of an alkali hydroxide, the bitumen base representing at least 72% by mass of said bituminous composition, characterized in that CO₂ is trapped in said bituminous composition and represents from 0.5 to 5% by mass, preferably from 0.5 to 4% by mass, and preferentially from 0.5 to 3% by mass, even more preferably from 0.5 to 2% or from 0.5 to 1.5% or from 0.7 to 2% by mass of the mass of the bitumen base and the mass of the bituminous composition is stable at 25° C. and under 1013.25 hPa, over a period Ps of at least 10 hours, preferably of at least 15 hours.

The mass of the bituminous composition is considered to be stable over a given period, in particular over a period Ps of 10 hours to 100 hours, especially 19 hours to 91 hours, and typically 19 hours, if this mass does not decrease by more than 2%, preferably, if this mass does not decrease by more than 1%, and preferentially does not decrease by more than 0.5%, and even more preferentially does not decrease by more than 0.05% relative to the initial mass of the composition, i.e., its mass at the beginning of the period considered. The stability of a composition as it is at a given time t can therefore be evaluated by measuring its mass at this time t, then at this time t+19 hours typically, or more generally t+ the evaluation period Ps. In other words, the mass of a bituminous composition is considered stable, if the mass m_{PS} of the bituminous composition at the end of the evaluation period Ps (=P_{S}=10 to 100 hours, especially=19 to 91 hours, and typically=19 hours) is greater than or equal to its mass m₀ at the beginning of the evaluation period (t=0)−2%, preferably is greater than or equal to m₀−1%, is greater than or equal to m₀−0.5%, and even more preferentially is greater than or equal to m₀−0.05%.

In the context of the invention, the stability of the mass of the bituminous composition is evaluated, leaving a bituminous composition at 25° C. and under atmospheric pressure (i.e. under a pressure of 1013.25 hPa). Under these conditions, the atmosphere in which the bituminous composition is located has no influence. Typically, however, stability is evaluated in ambient air. In the context of the invention, it was found that when an alkali hydroxide had been incorporated into a bitumen base, it was then possible to incorporate CO₂ into the resulting matrix formed from the bitumen base/alkali hydroxide mixture without a total release of the incorporated CO₂ subsequently occurring. Indeed, although immediately after the incorporation of CO₂, a portion of it tends to dissipate back into the ambient atmosphere, after a certain time, this release ceases, which is reflected by a stabilization of the mass of the bituminous composition obtained. Thus, the stability of the mass of the bituminous composition accounts for the fact that the quantity of CO₂ trapped in said composition is stabilized. The inventors have demonstrated, within the scope of the invention, that this stabilization takes place while a significant portion of the mass of CO₂ initially incorporated is still trapped within the bituminous composition. In the context of the invention, the terms trapped CO₂ or incorporated CO₂ are used interchangeably. Trapped CO₂ or incorporated CO₂ means that CO₂ has been incorporated into the bituminous composition and remains present therein, either in the initial CO₂ form (i.e., the gaseous form) which has diffused within the bituminous composition, or in a modified form due to an interaction or reaction with any of the components present in the bituminous composition. Regardless of the form in which CO₂ is present, in the context of the invention, when it is a question of the mass of CO₂, it is the mass of CO₂ incorporated, even if the CO₂ is in a form which has reacted with the alkali hydroxide, especially.

In the context of the invention, the bituminous compositions are obtained by directly introducing gaseous CO₂ into the bitumen base modified by incorporation of an alkali metal hydroxide. In other words, the modified bitumen base is first prepared by incorporating an alkali hydroxide (even other additives as explained below), and then CO₂ gas trapping in the modified bitumen base. In particular, CO₂ was trapped in the bituminous composition following a trapping step, especially carried out by placing said bitumen base modified by incorporation of an alkali hydroxide into a CO₂ pressure vessel, followed by a step of releasing a portion of the trapped CO₂ until the mass of the bituminous composition obtained stabilizes, this stabilization especially taking place 3 hours or more after the end of the trapping step, especially 5 to 10 hours after the end of the trapping step.

In particular, CO₂ is incorporated during this trapping step by placing the modified bitumen base in a vessel under CO₂ pressure, the vessel being maintained at a temperature ranging from 10 to 200° C., preferably ranging from 20 to 160° C., and preferentially ranging from 25 to 160° C., or even 80 to 160° C., the CO₂ pressure being especially chosen in the range from 5.10³ to 8.10⁴ hPa, preferably in the range from 5.10³ to 5.10⁴ hPa, and preferentially in the range from 1.10⁴ to 3.10⁴ hPa.

Once the mass of the bituminous composition has been stabilized, it remains stable if the bituminous composition is maintained at 25° C. and under atmospheric pressure. Typically, in the context of the invention, bituminous compositions comprising a bitumen base in which an alkali hydroxide has been incorporated have a mass which is stable at 25° C. and under 1013.25 hPa, over a period Ps of at least 10 hours, preferably at least 15 hours, and typically 19 hours. In other words, over a period Ps of at least 10 hours, preferably at least 15 hours, and typically 19 hours, this mass does not decrease by more than 2%, preferably, this mass does not decrease by more than 1%, and preferentially does not decrease by more than 0.5%, and even more preferentially does not decrease by more than 0.05% relative to the initial mass of the composition, i.e., its mass at the beginning of the period Ps considered. A bituminous composition according to the invention has a stable mass, while it has a quantity of CO₂ which has been incorporated into the bituminous composition and which remains trapped in said bituminous composition. This quantity of CO₂, which may be described as stabilized, represents from 0.5 to 5% by mass, preferably from 0.5 to 4% by mass of the mass of the bitumen base, and preferentially from 0.5 to 3% by mass of the mass of the bitumen base, and even more preferably from 0.5 to 2% by mass or from 0.5 to 1.5% by mass or from 0.7 to 2% by mass, of the mass of the bitumen base present in the bituminous composition. The quantity of CO₂ can be determined by weighing.

In the context of the invention, the masses can be determined by weighing, with a precision balance, in particular to within 0.0001 g (for example, Sartorius Practum 224-1S balance). In particular, the weighing is done at 25° C. and under atmospheric pressure (1013.25 hPa).

The bituminous compositions according to the invention are obtained by placing an original bituminous composition (also called modified bitumen base) under CO₂ pressure. The original bituminous composition comprises all the components of the desired bituminous composition, and therefore, in particular, the alkali hydroxide, with the exception of CO₂. In particular, the CO₂ is incorporated by placing such an original bituminous composition in a vessel under CO₂ pressure, the vessel being maintained at a temperature ranging from 10 to 200° C., preferably ranging from 20 to 160° C., and preferentially ranging from 25 to 160° C., or even 80 to 160° C., the CO₂ pressure being especially chosen in the range from 5.10³ to 8.10⁴ hPa (equivalent to 5-80 bar), preferably of 5.10³ to 5.10⁴ hPa, and preferentially in the range from 1.10⁴ to 3.10⁴ hPa. The mass of CO₂ incorporated into a bituminous composition, regardless of the form in which CO₂ is present in said composition, corresponds to the difference between the mass of said bituminous composition and the mass of the same original bituminous composition. The mass of CO₂ incorporated can be monitored over time, by following the mass of the bituminous composition. At the end of the CO₂ trapping step, especially if trapping is continued until the CO₂ composition is saturated, when the bituminous composition obtained comprising trapped CO₂ is then stored at 25° C. and under atmospheric pressure, first, there is a phase of release of part of the incorporated CO₂, which is reflected by a loss of mass of the composition. Then, this release ceases, even though a portion of the CO₂ remains trapped in the bituminous composition. This stabilization of the CO₂ incorporated in the bituminous composition is reflected by stabilization of the mass of the bituminous composition. It is, in particular, these stabilized bituminous compositions which are the subject of the invention. In the bituminous compositions according to the invention, it is a question of trapped CO₂, but within the composition, the trapped CO₂, or at least a portion of the trapped CO₂, may not be in the CO₂ form, but rather may have reacted with one of the components present or incorporated in the bituminous composition, and especially be in the form of one or more products of the reaction with the alkali hydroxide.

Thus, the period Ps over which the mass of the bituminous composition according to the invention is stable starts, after a release phase Pr, during which a portion of the trapped CO₂ is released from the bituminous composition. This release phase Pr is, most often from 5 to 10 hours, and typically 5 hours, after the end of the CO₂ trapping step. The end of the CO₂ trapping step especially corresponds to the moment when the bituminous composition is no longer under CO₂ pressure. During this release phase Pr following the trapping of the CO₂, the bituminous composition may be placed at 25° C. and under 1013.25 hPa. It is also possible for the bituminous composition to be subjected to heating during this release phase Pr, which will have the effect of accelerating the release of a portion of the CO₂ and thus reducing the duration of the release phase. When the release phase Pr is complete, the remaining CO₂ is trapped within the bituminous composition, under so-called standard storage conditions (at 25° C. and under 1013.25 hPa), which results in stabilization of the mass of the bituminous composition. The mass of the bituminous composition is understood as the mass of all the components present (in particular the bitumen base, the alkali hydroxide introduced, and any other components present) but also of the CO₂ trapped in the bituminous composition when the mass of the composition is measured.

Thus, in the context of the invention, it has been observed that the prior incorporation of an alkali hydroxide into a bituminous composition then makes it possible to trap a quantity of CO₂ in said bitumen composition in a lasting way. In the previous application WO 2018/206489, the applicant had proposed modifying bitumen bases by incorporating an alkali hydroxide such as NaOH and an adhesion promoter of the amine, diamine, polyamine, alkyl amidoamine amidopolyamine or imidazoline type, for producing bituminous compositions with improved ageing resistance. Surprisingly, in the context of the invention, it has been demonstrated that trapping CO₂, although it is capable of reacting with the alkali hydroxide present, does not lead to a significant alteration in the ageing resistance properties of the bituminous compositions obtained; this was by no means obvious.

In addition, other bituminous compositions incorporating components known to be porous and gas absorbent, such as clays (especially described in application WO 2019/122670), do not allow satisfactory trapping of CO₂. The tests carried out presented in the examples showed that, in this case, the release of CO₂, after its trapping, extended over a long period.

Thus, the invention proposes both compositions which allow sufficient storage of CO₂ to be of interest in combatting the greenhouse effect and global warming and which are satisfactory, in terms of performance to meet the requirements, especially stability under operating stresses, in the roadway and industrial application fields.

According to advantageous embodiments, the bitumen base has been modified by incorporating from 0.1 to 9% by mass, preferably from 0.2 to 4.5% by mass, and preferentially from 0.2 to 2% by mass of alkali hydroxide, relative to the mass of the bitumen base.

In general, in the compositions according to the invention, CO₂ is present, at least in part, in the bituminous composition in the form of one or more reaction products with the alkali hydroxide.

In particular, the alkali hydroxide is NaOH or KOH.

Thus, when the alkali hydroxide is NaOH, at least a portion of the incorporated NaOH, or even all of the incorporated NaOH, will be able to react with the trapped CO₂ and will be present in the bituminous composition in the form of one or more products of the reaction between CO₂ and NaOH, especially in the form of NaHCO₃ and Na₂CO₃, or exclusively in the form of NaHCO₃. When the alkali hydroxide is KOH, at least a portion of the incorporated KOH, or even all of the incorporated KOH, will be able to react with the trapped CO₂ and will be present in the bituminous composition in the form of one or more products of the reaction between CO₂ and KOH, especially in the form of KHCO₃ and K₂CO₃, or exclusively in the form of KHCO₃.

According to another of its objects, the invention concerns a method for preparing a bituminous composition comprising a bitumen base representing at least 72% by mass of said bituminous composition, said method comprising the following successive steps:
a) obtaining a modified bitumen base, comprising the incorporation of an alkali hydroxide into a bitumen base, said incorporation being followed by or accompanied by mixing, preferably under heating at a temperature in the range from 90 to 230° C., preferably in the range from 120 to 200° C., and preferentially in the range from 120 to 180° C.,
b) trapping CO₂ in the modified bitumen base at a mass content especially representing from 0.8 to 5.8% by mass, preferably from 0.8 to 4.5% by mass, preferentially from 0.8 to 3.5% by mass, and even more preferentially from 0.8 to 2.6% by mass, or from 0.8 to 1.8% by mass of the mass of the bitumen base.

The invention also relates to a method for preparing a bituminous composition comprising the following successive steps:
a) obtaining a modified bitumen base, comprising the incorporation of an alkali hydroxide into a bitumen base, said incorporation being followed by or accompanied by mixing, preferably under heating at a temperature in the range from 90 to 230° C., preferably in the range from 120 to 200° C., and preferentially in the range from 120 to 180° C.,
b) trapping CO₂ in the modified bitumen base until saturation with CO₂.

In particular, in the methods according to the invention, CO₂ is incorporated by placing the modified bitumen base in a vessel under CO₂ pressure, the vessel being maintained at a temperature ranging from 10 to 200° C., preferably ranging from 20 to 160° C., and preferentially ranging from 25 to 160° C., or even 80 to 160° C., the CO₂ pressure being especially chosen in the range from 5.10³ to 8.10⁴ hPa, preferably in the range from 5.10³ to 5.10⁴ hPa, and preferentially in the range from 1.10⁴ to 3.10⁴ hPa.

Advantageously, in the methods according to the invention, in step a), the mass of alkali hydroxide incorporated represents from 0.1 to 9% by mass, preferably from 0.2 to 4.5%, and preferentially from 0.2 to 2% by mass, of the mass of the bitumen base.

The alkali hydroxide is preferably NaOH or KOH.

According to advantageous embodiments of the methods according to the invention, during step a), an adhesion promoter chosen from amines, diamines, polyamines, alkyl amidoamines, amidopolyamines, imidazolines, and mixtures thereof, is also incorporated into the bitumen base, said adhesion promoter preferably being introduced in a proportion of 0.01 to 2.5% by mass, preferentially 0.05 to 1.1% by mass, and even more preferably 0.1 to 0.4% by mass, of the total mass of the bitumen base.

According to particular embodiments of the methods according to the invention, during step a), one or more polymers chosen from olefin polymers and elastomers, especially from cross-linkable elastomers, are also incorporated into the bitumen base, said polymer(s) preferably being introduced in a proportion preferably of 0.1 to 12% by mass, preferably of 0.3 to 10% and preferentially of 0.5 to 7% by mass, of the mass of the bitumen base.

The methods according to the invention may comprise a step of releasing a portion of the trapped CO₂ from the bituminous composition resulting from step b), at the end of which the mass of the bituminous composition is stable.

In particular, said releasing step leads to a quantity of CO₂ trapped in the bituminous composition, corresponding to 0.5 to 5% by mass, preferably to 0.5 to 4% by mass, and preferentially to 0.5 to 3% by mass, and even more preferably 0.5 to 2% or 0.5 to 1.5% or 0.7 to 2% by mass, relative to the mass of the bitumen base.

The invention also relates to the bituminous compositions which can be obtained according to the methods of the invention, regardless of their variant embodiment.

According to another of its aspects, the invention concerns bituminous compositions comprising a bitumen base and one or more reaction products of CO₂ with an alkali hydroxide, especially chosen from NaOH and KOH.

In particular, the invention concerns bituminous compositions comprising one or more reaction products of CO₂ with NaOH. In particular, such compositions comprise NaHCO₃, or even NaHCO₃ and Na₂CO₃, as reaction product(s) of CO₂ with NaOH. The invention concerns bituminous compositions comprising from 2 to 210 mmol (millimoles) of NaHCO₃ and Na₂CO₃, per 100 g of bituminous composition, preferably from 5 to 80 mmol of NaHCO₃ and Na₂CO₃ per 100 g of bituminous composition, and even more preferably from 5 to 40 mmol of NaHCO₃ and Na₂CO₃ per 100 g of bituminous composition. The invention also concerns bituminous compositions comprising from 2 to 210 mmol (millimoles) of Na₂CO₃ per 100 g of bituminous composition, preferably from 5 to 80 mmol of Na₂CO₃ per 100 g of bituminous composition, and even more preferably from 5 to 40 mmol of Na₂CO₃ per 100 g of bituminous composition.

The invention also concerns bituminous compositions comprising one or more reaction products of CO₂ with KOH. In particular, such compositions comprise KHCO₃, or even KHCO₃ and K₂CO₃, as reaction product(s) of CO₂ with KOH. The invention concerns bituminous compositions comprising from 2 to 145 mmol (millimoles) of KHCO₃ and K₂CO₃ per 100 g of bituminous composition, preferably from 3 to 53 mmol of KHCO₃ and K₂CO₃ per 100 g of bituminous composition, and even more preferably from 3 to 27 mmol of KHCO₃ and K₂CO₃ per 100 g of bituminous composition. The invention also concerns bituminous compositions comprising from 2 to 145 mmol (millimoles) of K₂CO₃ per 100 g of bituminous composition, preferably from 3 to 53 mmol of K₂CO₃ per 100 g of bituminous composition, and even more preferably from 3 to 27 mmol of K₂CO₃ per 100 g of bituminous composition.

In the compositions according to the invention, whatever the variant embodiment, the bitumen base represents at least 72% by mass, preferably at least 83% by mass and preferentially at least 89% by mass of the total mass of the bituminous composition. With such quantities of bitumen base present within the compositions according to the invention, it is clear that the bituminous compositions according to the invention do not include bituminous emulsions. Indeed, in bituminous emulsions, the quantity of bitumen base is much smaller, due to the presence of an aqueous phase.

Advantageously, a composition according to the invention, whatever the variant embodiment, also comprises an adhesion promoter chosen from amines, diamines, polyamines, alkyl amidoamines, amidopolyamines, imidazolines, and mixtures thereof, said adhesion promoter preferably representing 0.01 to 2.5% by mass, preferentially 0.05 to 1.1% by mass, and even more preferably 0.1 to 0.4% by mass, of the mass of the bitumen base.

According to particular embodiments, a composition according to the invention, whatever the variant embodiment, also comprises one or more polymers chosen from olefin polymers and elastomers, especially from cross-linked or cross-linkable elastomers, preferably representing from 0.1 to 12% by mass, preferentially from 0.3 to 10% by mass, and even more preferably from 0.5 to 7% by mass, of the mass of the bitumen base.

The bituminous compositions according to the invention find different applications. Thus, the invention also has as its object:
the use of a bituminous composition according to the invention to prepare a waterproofing coating, a membrane or an impregnation layer; as well as the methods for preparing such a waterproofing coating, such a membrane or such an impregnation layer;
bituminous binders comprising a bituminous composition according to the invention;
the use of a bituminous composition according to the invention as a bituminous binder in a bituminous mix comprising a bituminous composition according to the invention, aggregates, and, optionally, mineral and/or synthetic fillers; as well as methods for preparing such a bituminous mix;
the use of a bituminous composition according to the invention as a bituminous binder in an asphalt comprising a bituminous composition according to the invention, and mineral and/or synthetic fillers; as well as the methods for preparing such an asphalt;
as well as the use of a bituminous composition according to the invention, as a bituminous binder in a surface coating, hot mix, cold mix, cold cast mix, emulsion gravel or roadway surface, which comprises a bituminous composition according to the invention, aggregates and/or recycled millings; as well as methods for the preparation of such a surface coating, hot-mix, cold-mix, cold cast mix, of such a emulsion gravel or roadway surface.

According to a particular aspect, the invention concerns a method for preparing an asphalt, characterized in that it comprises the hot mixing of a bituminous composition according to the invention or obtainable according to a method according to the invention, with mineral and/or synthetic fillers. Advantageously, the hot mixing with the bituminous composition can be carried out at a temperature of 80 to 200° C., preferably 80 to 180° C. and preferentially 100 to 160° C.

The invention also relates to the use of an alkali hydroxide in a bituminous composition in which CO₂ is incorporated, in order to stabilize the quantity of CO₂ remaining trapped within said bituminous composition.

### Bitumen

The invention relates to bitumen compositions modified by the addition of at least one additive or adjuvant, also called bituminous compositions. These can comprise one or more bitumens. The bitumen or bitumens present in the bituminous compositions according to the invention are called “bitumen base” and constitute the majority content of the composition, i.e., represent at least 72% by mass of the total mass of the bituminous composition, and preferably at least 83%, or even at least 89% and even at least 95% by mass of the total mass of the bituminous composition. Among the bitumens which can be used according to the invention, mention may first be made of bitumens of natural origin, those contained in deposits of natural bitumen, natural asphalt or bituminous sands and bitumens originating from the refining of crude oil. In the context of the invention, the bitumen(s) used are advantageously chosen from bitumens originating from the refining of crude oil, in particular bitumens containing asphaltenes or pitches. The bitumens can be obtained by conventional methods for the manufacture of bitumens in refineries, in particular by direct distillation and/or vacuum distillation of petroleum. These bitumens may optionally be visbroken and/or deasphalted and/or air rectified. It is common practice to carry out vacuum distillation of atmospheric residues coming from the atmospheric distillation of crude oil. Consequently, this manufacturing method corresponds to the succession of atmospheric distillation and vacuum distillation, the feedstock feeding the vacuum distillation corresponding to atmospheric residues. These vacuum residues from the vacuum distillation tower can also be used as bitumens. It is also common practice to inject air into a feedstock usually composed of distillates and heavy products originating from the vacuum distillation of atmospheric residues from petroleum distillation. This method makes it possible to obtain a blown, semi-blown, oxidized, air-rectified or partially air-rectified bitumen. Different bitumens obtained by refining methods can be combined in the compositions according to the invention, to obtain the best compromise in terms of technical performance. In conventional methods for the manufacture of bituminous compositions, the operation is carried out at manufacturing temperatures comprised between 90° C. and 230° C., preferably between 120° C. and 200° C., and with stirring for a period of at least 10 minutes, preferably comprised between 30 minutes and 10 hours, more preferentially between 1 hour and 6 hours. The term “manufacturing temperature” means the temperature to which the bitumen or bitumens are heated before mixing with the additives, as well as the mixing temperature. The temperature and duration of heating vary according to the quantity of bitumen used and are defined by standard NF EN 12594. Blown bitumens can be manufactured in a blowing unit, by passing a stream of air and/or oxygen through an initial bitumen or mixture of bitumens. This operation can be carried out in the presence of an oxidation catalyst, for example phosphoric acid. Generally, blowing is carried out at high temperatures, around 200 to 300° C., for relatively long periods typically comprised between 30 minutes and 2 hours, continuously or in batches. The blowing time and temperature are adjusted depending on the desired properties of the blown bitumen and as on the quality of the starting bitumen.

Among the bitumens which can be used according to the invention, mention may also be made of recycling bitumens.

Bitumens may be hard grade bitumens (such as grades 10/20 and 20/30) or soft grade bitumens (such as grade 160/220) defined by EN 12591.

The invention is particularly suitable for cases where the bitumen base consists of a hard grade bitumen or a mixture of hard grade bitumens, in particular chosen from among bitumens of grade 35/50, 20/30 and 10/20.

The bitumen bases which can be used in the context of the invention preferably have a penetrability, measured at 25° C. according to standard EN 1426, of 5 to 330 1/10 mm, preferably between 10 and 220 1/10 mm, more preferentially between 10 and 120 1/10 mm. In a known way, the so-called “needle penetrability” measurement is carried out by means of a standardized test NF EN 1426 at 25° C. (Pene). This penetrability characteristic is expressed in tenths of a millimeter (dmm or 1/10 mm). The needle penetrability, measured at 25° C., according to the standardized test NF EN 1426, represents the measurement of the penetration into a bitumen sample, after a time of 5 seconds, of a needle whose mass with its support is 100 g.

### Alkali Metal Hydroxide

Examples of alkali hydroxides include NaOH, KOH, Mg(OH)₂, Ca(OH)₂ or Li(OH)₂.

The alkali hydroxide may be introduced into the bitumen composition in the form of a suspension or solution in a solvent (especially water or ethanol) but is preferably introduced directly in the form of a powder or a set of particles, in particular an anhydrous alkali hydroxide. Advantageously, the alkali hydroxide used, and, in particular, the NaOH or KOH used, forms particles whose maximum particle size is equal to or less than 100 μm, and preferentially whose maximum particle size is equal to or less than 60 μm. In particular, the mean maximum size of the alkali hydroxide particles, and, in particular, NaOH or KOH, introduced is in the range from 10 to 100 μm, preferably in the range from 20 to 60 μm. The mean maximum particle size corresponds to the arithmetic mean of the maximum sizes of several particles, preferably 20 particles. Another way is to use alkali hydroxide particles, and, in particular, NaOH or KOH, with at least 80% by number of said particles having a maximum size in the range from 10 to 100 μm, preferably in the range from 20 to 60 μm. The maximum size of a particle, which, in general, is irregular in shape, corresponds to its largest dimension, especially measured with a microscope, and preferably a visible light microscope. This latter variant of determining the size of the particles used, which is not the preferred one, can be obtained on a population of 10, or preferentially 20, particles. The size of the particles introduced can be adjusted by various crushing or grinding techniques, for example by using a suitable crushing device, such as an IKA® A11 mill.

By adjusting the size of the alkali hydroxide particles introduced, as previously explained, it is possible to better control and optimally adjust the properties of the bituminous composition, especially in terms of stability with ageing.

In the context of the invention, the bituminous compositions are preferably obtained from a bitumen base and NaOH, and/or KOH, CO₂, and optionally from one or more components defined in the context of the invention.

In general, the alkali hydroxide introduced represents from 0.1 to 8% by mass, preferably from 0.2 to 3% by mass, and preferentially from 0.2 to 1.5% by mass, relative to the total mass of the bituminous composition.

Advantageously, the alkali hydroxide introduced represents from 0.1 to 9% by mass, preferably from 0.2 to 4.5% by mass, and preferentially from 0.2 to 2% by mass, relative to the mass of the bitumen base present in the bituminous composition.

### Other Optional Ingredients/Additives

The bituminous compositions according to the invention may also include an adhesion promoter, especially chosen from amines, diamines, polyamines, alkyl amidoamines, amidopolyamines, imidazolines and mixtures thereof. Such adhesion promoters are especially described in application WO 2018/206489 to which reference may be made for further details.

In particular, such an adhesion promoter is chosen from:
i) Amines of formula (I):

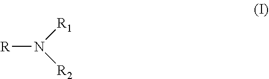

wherein:
R is a saturated or unsaturated, substituted or unsubstituted hydrocarbon group, optionally branched or cyclic, comprising 8 to 24 carbon atoms, for example, R is a hydrocarbon group derived from tallow fatty acids or tall oil fatty acids; and
R₁ and R₂, identical or different, are a hydrogen atom or a hydrocarbon group having 1 to 24 carbon atoms; R₁ and R₂ are preferably a hydrogen atom or a methyl group;
ii) Diamines and polyamines of formula (II):

R—(NH-L)n-NH₂ (II)

wherein:
R is as defined for (I),
L is a linear or branched hydrocarbon chain comprising from 1 to 6 carbon atoms, for example, L is —(CH₂)m- with m=1, 2 or 3 and,
n is an integer greater than or equal to 1, in particular, n is equal to 1, 2, 3, 4, 5 or 6,
iii) Alkyl amido amines of formula (III):

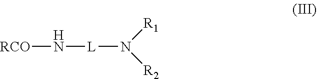

wherein R, R₁, R₂ and L are as defined for (I) and (II);
iv) Amidopolyamines of formula (IV) and imidazolines:

RCO—(NH-L)p-NH₂ (IV)
wherein R and L are as defined for (I) and (II), and p is an integer greater than or equal to 1, in particular p is an integer in the range from 1 to 10.

Advantageously, the adhesion promoter is selected from amines, diamines, polyamines, alkyl amidoamines and amidopolyamines comprising a fatty chain, and, in particular from those described above. In particular, the adhesion promoter is an amidopolyamine comprising a fatty chain, of formula:

RCO—(NH-L)p-NH₂ (IV)

where:
p is an integer greater than or equal to 1, in particular p is an integer in the range from 1 to 10,
L represents a linear or branched hydrocarbon chain comprising from 1 to 6 carbon atoms, for example, L is —(CH₂)m- with m=1, 2 or 3,
R is a saturated or unsaturated, substituted or unsubstituted, optionally branched or cyclic hydrocarbon-based group comprising 8 to 24 carbon atoms.

Preferably, the adhesion promoter used in the bituminous compositions according to the invention is a mixture of amidopolyamines of formula (IV) in which p is an integer in the range from 1 to 10, L is —(CH₂)₂—, and r corresponds to the hydrocarbon chains of tall oil fatty acids.

In general, when it is present, said adhesion promoter preferably represents 0.01 to 2% by mass, preferentially 0.05 to 1% by mass, and even more preferably 0.1 to 0.3% by mass, of the total mass of the bituminous composition according to the invention.

Advantageously, the adhesion promoter represents 0.01 to 2.5% by mass, preferentially 0.05 to 1.1% by mass, and even more preferably 0.1 to 0.4% by mass, relative to the mass of the bitumen base present in the bituminous composition.

The bituminous compositions according to the invention may also include one or more polymers. In particular, an olefin polymer and/or an elastomer, especially a cross-linked or cross-linkable elastomer, can be incorporated into the bituminous compositions according to the invention.

The bituminous compositions according to the invention may, in particular, comprise one or more olefin polymers especially chosen from:
(a1) random or block copolymers, preferably random copolymers, of ethylene and of a monomer chosen from glycidyl acrylate and glycidyl methacrylate, comprising from 50% to 99.7% by mass, preferably from 60% to 95% by mass, more preferentially from 60% to 90% by mass of ethylene;
(b1) random or block terpolymers, preferably random, of ethylene, a monomer A chosen from vinyl acetate, C1 to C6 alkyl acrylates and C1 to C6 alkyl methacrylates and a monomer B chosen from glycidyl acrylate and glycidyl methacrylate; in particular, said terpolymers comprising from 0.5% to 40% by mass, preferably from 5% to 35% by mass, more preferentially from 10% to 30% by mass of units derived from monomer A and, from 0.5% to 15% by mass, preferably from 2.5% to 15% by mass of units derived from monomer B, the remainder being formed from units derived from ethylene;
(c1) copolymers resulting from the grafting of a monomer B chosen from glycidyl acrylate and glycidyl methacrylate, onto a polymeric substrate; in particular, the polymeric substrate is chosen from polyethylenes, especially low density polyethylenes, polypropylenes, random or block copolymers, preferably random copolymers, of ethylene and vinyl acetate, and random or block copolymers, preferably random copolymers, of ethylene and C1-C6 alkyl acrylate or C1-C6 alkyl methacrylate, comprising from 40% to 99.7% by mass, preferably from 50% to 99% by mass of ethylene; preferably, said grafted copolymers comprise from 0.5% to 15% by mass, preferably from 2.5% to 15% by mass, of grafted units derived from monomer B.

The bituminous compositions according to the invention may, in particular, comprise one or more elastomers, especially chosen from cross-linked or cross-linkable elastomers. The cross-linked elastomers will be introduced in their cross-linkable form into the compositions according to the invention and cross-linked in situ. Such elastomers known to be incorporated into a bituminous composition are, especially, the following copolymers: SB (styrene-butadiene-block copolymer), SBS (styrene-butadiene-styrene block copolymer), SIS (styrene-isoprene-styrene), SBS* (styrene-butadiene-styrene star block copolymer), SBR (styrene-b-butadiene-rubber) and EPDM (modified ethylene propylene diene).

According to certain particular embodiments, a bituminous composition according to the invention comprises from 0.05% to 10% by mass, preferably from 0.1% to 8% by mass and preferentially from 0.3 to 6% by mass, of olefin polymer(s) and/or elastomer(s), relative to the total mass of said bituminous composition.

Advantageously, the mass of olefin polymer(s) and/or elastomer(s) represents from 0.1 to 12% by mass, preferably from 0.3 to 10% and preferentially from 0.5 to 7% by mass, relative to the mass of the bitumen base present in the bituminous composition.

### Bituminous Compositions, Also Called Bituminous Compositions, According to the Invention

Although it is not excluded for the bituminous compositions according to the invention to comprise one or more other additives, especially chosen from those conventionally used in bituminous compositions, preferably the bitumen base, trapped CO₂, alkali hydroxide, or even the adhesion promoter and/or elastomer and/or olefin polymer represent at least 90% by mass, preferably at least 95% by mass, or even 100% by mass of the total mass of the bituminous composition.

The various components of the bituminous composition are dispersed in the bituminous composition, and therefore in the bitumen base.

Examples of particularly preferred bituminous compositions are given below.

In particular, the invention concerns bituminous compositions comprising a bitumen base modified by incorporation of an alkali hydroxide and in which CO₂ has been incorporated and remains trapped, optionally in a form which has reacted chemically with another component present in the composition.

In particular, such bituminous compositions comprise a bitumen base, modified by incorporation of:
0.1 to 9% by mass, preferably 0.2 to 4.5% by mass, and preferentially 0.2 to 2% by mass, relative to the mass of the bitumen base, of alkali hydroxide, and, in particular, NaOH or KOH or a mixture thereof,
an adhesion promoter chosen from amines, diamines, polyamines, alkyl amidoamines, amidopolyamines, imidazolines, and mixtures thereof, in a proportion of 0.01 to 2.5% by mass, preferably of 0.05 to 1.1% by mass, and even more preferably of 0.1 to 0.4% by mass, of the mass of the bitumen base,
optionally, one or more polymers chosen from olefin polymers and elastomers, especially from cross-linked or cross-linkable elastomers, in a proportion of from 0.1 to 12% by mass, preferentially from 0.3 to 10% by mass and even more preferably from 0.5 to 7% by mass, of the mass of the bitumen base,
CO₂ which remains trapped in said composition, optionally in a form which has reacted chemically with another component present in said bituminous composition, and which represents from 0.5 to 5% by mass, preferably 0.5 to 4% by mass, and preferentially 0.5 to 3% by mass, and even more preferably 0.5 to 2% or 0.5 to 1.5% or 0.7 to 2% by mass, relative to the mass of the bitumen base.

The compositions below are particularly preferred:
1) bituminous compositions, which comprise a bitumen base, modified by incorporating:
   0.1 to 9% by mass, relative to the mass of the bitumen base, of alkali hydroxide, and, in particular, of NaOH or KOH or of a mixture thereof,
   an adhesion promoter chosen from amines, diamines, polyamines, alkyl amidoamines, amidopolyamines, imidazolines, and mixtures thereof, in a proportion of 0.01 to 2.5% by mass relative to the mass of the bitumen base,
   optionally, one or more polymers selected from olefin polymers and elastomers, especially from cross-linked or cross-linkable elastomers, in a proportion of 0.1 to 12% by mass, relative to the mass of the bitumen base,
   CO₂ which remains trapped in said composition, optionally in a form which has reacted chemically with another component present in said bituminous composition, and which represents from 0.5 to 5% by mass, preferably from 0.5 to 4% by mass, and preferentially from 0.5 to 3% by mass, and even more preferably from 0.5 to 2% or even from 0.5 to 1.5% or even from 0.7 to 2% by mass, relative to the mass of the bitumen base;
2) bituminous compositions, which comprise a bitumen base, modified by the incorporation of:
   0.2 to 4.5% by mass, relative to the mass of the bitumen base, of alkali hydroxide, and, in particular, of NaOH or KOH or of a mixture thereof,
   an adhesion promoter chosen from amines, diamines, polyamines, alkyl amidoamines and amidopolyamines, imidazolines, and mixtures thereof, in a proportion of 0.05 to 1.1% by mass, relative to the mass of the bitumen base,
   optionally, one or more polymers selected from olefin polymers and elastomers, especially from cross-linked or cross-linkable elastomers, in a proportion of 0.3 to 10% by mass, relative to the mass of the bitumen base,
   CO₂ which remains trapped in said composition, optionally in a form which has reacted chemically with another component present in said bituminous composition, and which represents from 0.5 to 5% by mass, preferably from 0.5 to 4% by mass, and preferentially from 0.5 to 3% by mass, and even more preferably from 0.5 to 2% or from 0.5 to 1.5% or from 0.7 to 2% by mass relative to the mass of the bitumen base;
3) bituminous compositions, which comprise a bitumen base, modified by incorporation of:
   0.2 to 2% by mass, relative to the mass of the bitumen base, of alkali hydroxide, and, in particular, NaOH or KOH or a mixture thereof,
   an adhesion promoter chosen from amines, diamines, polyamines, alkyl amidoamines, amidopolyamines, imidazolines, and mixtures thereof, in a proportion of 0.1 to 0.4% by mass, relative to the mass of the bitumen base,
   optionally, one or more polymers chosen from olefin polymers and elastomers, especially from cross-linked or cross-linkable elastomers, in a proportion of from 0.5 to 7% by mass, relative to the mass of the bitumen base,
   CO₂ which remains trapped in said composition, optionally in a form which has reacted chemically with another component present in said bituminous composition, and which represents from 0.5 to 5% by mass, preferably 0.5 to 4% by mass, and preferentially 0.5 to 3% by mass, and even more preferably 0.5 to 2% or 0.5 to 1.5% or 0.7 to 2% by mass, relative to the mass of the bitumen base.

In such compositions, preferably, the adhesion promoter(s), or even the polymer(s) present, are chosen from those specifically described in the context of the present description.

It is possible that the trapped CO₂ reacts with the alkali hydroxide introduced into the composition. When the alkali hydroxide is NaOH, it may be, within the bituminous composition, totally or partially in the form of one or more reaction products with trapped CO₂, especially in the form of a mixture of NaHCO₃ and Na₂CO₃, or even exclusively in the form of NaHCO₃. When the alkali hydroxide is KOH, it may be, within the bituminous composition, totally or partially in the form of one or more reaction products with trapped CO₂, especially in the form of a mixture of KHCO₃ and K₂CO₃, or even exclusively in the form of KHCO₃.

It is possible that such compositions comprise one or more other additives. However, it is preferable that the above-mentioned components and the bitumen base constitute the bulk of the bituminous composition. In such compositions, the bitumen base represents at least 72% by mass of the total mass of the bituminous composition, and preferably at least 83%, or even at least 89% and even at least 95% by mass of the total mass of the bituminous composition. This percent will especially depend on the presence or absence of additional polymers. According to particular embodiments of the above-mentioned compositions, the bitumen base can be modified solely by incorporating the listed components.

Of course, advantageously, these bituminous compositions will have a mass which remains stable at 25° C. and under 1013.25 hPa, over a period Ps of at least 10 hours, preferably at least 15 hours. This stability criterion is as defined above in the context of the present description.

### Preparation of Bituminous Compositions According to the Invention and Preparation Method According to the Invention

The bituminous compositions of the invention can be prepared by any method known to those skilled in the art. As a general rule, these methods include mixing the components and heating the mixture. The bitumen can be heated before mixing. Usually, the bitumen is heated before mixing, and the additive or additives are added to the bitumen without having been previously heated. According to a particular embodiment of the invention, a bitumen composition is prepared by contacting:
the bitumen base;
the desired mass of alkali metal hydroxide;
optionally one or more other additive(s).

The bitumen base is used in such a quantity that, in the end, it represents at least 72% by mass of said bituminous composition obtained. Conventionally, the mixture of the bitumen base and the alkali hydroxide, or even of the other additive(s) present, is carried out at temperatures ranging from 90 to 230° C., preferably ranging from 120 to 200° C., and preferentially ranging from 120 to 180° C.

Such a mixture is prepared with stirring, especially, for a period of 5 minutes to 10 hours, preferably from 10 minutes to 3 hours, preferentially from 10 to 90 minutes and even more preferably from 20 to 90 minutes. The mixing may be carried out by means of stirring producing high shear or stirring producing low shear. In particular, the mixing is carried out with stirring at 100 to 1000 rotations per minute (rpm), preferably from 100 to 600 rpm, and preferentially from 150 to 500 rpm. Stirring is carried out in such a way as to facilitate the dispersion and good distribution of the alkali hydroxide in the bitumen base. The person skilled in the art will adjust the time and power of the stirring, to obtain a satisfactory distribution.

When an adhesion promoter and/or one or more polymers are incorporated into the bitumen base, they are preferably introduced after the alkali hydroxide.

The incorporation of CO₂ into the composition leading to it being trapped in the bitumen base is carried out, after the incorporation of the alkali hydroxide, and if one or more other components are incorporated, preferably after this incorporation as well. Such trapping can be carried out by placing the bitumen base modified by incorporation of the alkali hydroxide, or even of one or more other additives, in a vessel under CO₂ pressure, the vessel being maintained at a temperature generally ranging from 10 to 200° C., preferably ranging from 20 to 160° C., especially from 25 to 160° C. The CO₂ pressure will especially be chosen in the range from 5.10³ to 8.10⁴ hPa (hectopascal, corresponding to 5-80 bars), preferably in the range from 5.10³ to 5.10⁴ hPa, and preferentially in the range from 1.10⁴ to 3.10⁴ hPa. These conditions will be maintained in the pressure vessel for a duration, usually from 5 minutes to 100 hours. This duration will be adapted, by a person skilled in the art, especially as a function of the temperature chosen during the incorporation of CO₂, the CO₂ pressure used and the quantity of CO₂ desired. For example, CO₂ will be incorporated over a duration of 5 h to 50 h, when a temperature of 80 to 160° C. is used, and over a duration of 30 minutes to 5 h when a temperature of 10 to 40° C. is used, for the same pressure. The CO₂ incorporation step can be carried out with or without mechanical stirring. If such stirring is present, the stirring speed can, for example, vary between 200 rpm and 6000 rpm.

Incorporation of CO₂ is favored at the lowest temperatures. A person skilled in the art will be able to work with the three variables of T° C., pressure and duration of exposure of the composition to a CO₂ pressure, in order to obtain optimum incorporation of CO₂ within the composition, and especially to obtain saturation of the composition with CO₂.

In general, at the end of the CO₂ trapping step, the CO₂ trapped represents from 0.8 to 5.8% by mass, preferably from 0.8 to 4.5% by mass, preferentially from 0.8 to 3.5% by mass, and even more preferably from 0.8 to 2.6% by mass, or from 0.8 to 1.8% by mass, of the mass of the bitumen base.

After such a step of trapping CO₂, a step of releasing a portion of the trapped CO₂ generally occurs. This release step or phase Pr is generally at least 3 hours, or even at least 5 hours, most often from 5 to 10 hours, and typically 5 hours, after the end of the CO₂ trapping step. The end of the CO₂ trapping step especially corresponds to the moment when the bituminous composition is no longer under CO₂ pressure. This release can occur naturally when the bituminous composition is stored at 25° C. and under 1013.25 hPa. Such a release phase under these conditions typically lasts at least 5 hours, and especially from 5 to 10 hours. It is also possible for the bituminous composition to be subjected to heating during this release phase Pr, which will have the effect of accelerating the release of a portion of the CO₂ and thus reducing the duration of the release phase. During such a phase of releasing the initially incorporated CO₂, in general a quantity corresponding to 0.1 to 0.7% by mass of CO₂ relative to the bitumen mass may be released, and leads to a mass % of CO₂ relative to the mass of the bitumen base, which still remains at least equal to 0.5%, and typically in the range from 0.5 to 5%, 0.5 to 4%, 0.5 to 3%, 0.5 to 2% or 0.5 to 1.5% or 0.7 to 2%. When the release phase Pr is complete, the remaining CO₂ is trapped within the bituminous composition, under so-called standard storage conditions (at 25° C. and under 1013.25 hPa), which is reflected by a stabilization of the mass of the bituminous composition. The mass of the bituminous composition is understood as the mass of all the components present (in particular the bitumen base, the alkali hydroxide introduced, and any other components present) but also of the CO₂ trapped in the bituminous composition when the mass of the composition is measured.

It is possible that a portion of the CO₂ trapped during the trapping step has reacted with the alkali hydroxide. The so-called trapped CO₂ can therefore be found in the form of CO₂ and reaction product(s) with alkali hydroxide, such as NaHCO₃ and Na₂CO₃ when the alkali hydroxide is NaOH or such as KHCO₃ and K₂CO₃ when the alkali hydroxide is KOH. Thus, the CO₂ which is eliminated during this release phase Pr may be all or part of the CO₂ trapped in the composition, still in the CO₂ form.

The invention also relates to the bituminous compositions which can be obtained by the method described in the context of the invention, and, in particular, to the bituminous compositions, which can be described as stabilized, which are obtainable at the end of the step of releasing a portion of the trapped CO₂.

The characteristics described in the preceding sections also apply to the preparation methods according to the invention. Thus, the components used in the preparation method will preferably be chosen from those described above and introduced in proportions which make it possible to produce the quantities given for the description of the bituminous compositions according to the invention.

### Use and Implementation of Bituminous Compositions According to the Invention

Various uses of the bituminous compositions obtained according to the invention are envisaged. In particular, the bitumen compositions according to the invention can be used as bituminous binder. The bituminous binder or bituminous composition according to the invention can, in turn, be used to prepare a combination with aggregates, especially roadway aggregates. As regards roadway applications, the invention especially relates to bituminous mixes as materials for the construction and maintenance of road foundations and their covering, as well as for carrying out all road works.

A bituminous mix is understood to mean a mixture of a bituminous binder with aggregates and, optionally, mineral and/or synthetic fillers. The bituminous mix comprises a bituminous binder as described in the context of the invention, and, optionally, mineral and/or synthetic fillers, preferably chosen from fines, sand, chippings and recycled millings. The aggregates are mineral and/or synthetic aggregates, especially recycled millings, of dimensions greater than 2 mm, preferably comprised between 2 mm and 20 mm.

Thus, the invention also relates to a method for the preparation of a bituminous mix comprising the hot mixing of a bituminous composition according to the invention, with aggregates, and, optionally, mineral and/or synthetic fillers.

The bituminous binder according to the invention can advantageously be used to prepare a surface coating, a hot mix, a cold mix, a cold cast mix or an emulsion gravel. As regards roadway applications, the invention also relates to asphalts as materials for manufacturing and covering sidewalks.

Asphalt is understood to mean a mixture of bituminous binder with mineral and/or synthetic fillers. An asphalt comprises a bituminous composition as described in the context of the invention and mineral fillers such as fines, sand or gravel and/or synthetic fillers. The mineral fillers consist of fines (particles with dimensions of less than 0.063 mm), sand (particles with dimensions comprised between 0.063 mm and 2 mm) and, optionally, gravel (particles with dimensions of greater than 2 mm, preferably comprised between 2 mm and 4 mm). Asphalts exhibit 100% compactness and are mainly used to make and cover sidewalks, while mixes exhibit less than 100% compactness and are used to make roads. Unlike mixes, asphalts are not roller compacted when they are laid.

Thus, the invention also relates to a method for preparing an asphalt comprising hot mixing of a bituminous composition according to the invention, with mineral and/or synthetic fillers.

Another aspect of the invention relates to the use of a bitumen composition in various industrial applications, especially for preparing a waterproofing coating, membrane or impregnation layer. As regards the industrial applications of bituminous compositions, mention may be made of the manufacture of waterproofing membranes, noise-reducing membranes, insulating membranes, surface coverings, carpet tiles and impregnation layers.

Because of the incorporation of CO₂, the compositions according to the invention have a lower viscosity than conventional bituminous compositions. It is thus possible to implement them using lower temperatures. Thus, the invention also relates to methods for the preparation of a mix comprising the hot mixing, at a temperature of 80 to 200° C., preferably of 80 to 180° C., and preferentially of 100 to 160° C., of a bituminous composition according to the invention or obtainable according to a method according to the invention, with aggregates and/or recycled millings, and, optionally, mineral and/or synthetic fillers.

The invention also relates to a method for the preparation of an asphalt comprising the hot mixing, at a temperature of 80 to 200° C., preferably of 80 to 180° C., and preferentially of 100 to 160° C., of a bituminous composition according to the invention or obtainable according to a method according to the invention, with mineral and/or synthetic fillers.

The invention also concerns the use of an alkali hydroxide in a bituminous composition in which CO₂ is incorporated, in order to stabilize the quantity of CO₂ remaining trapped within said bituminous composition.

The characteristics described in relation to the bituminous composition and/or the method for preparing a composition according to the invention apply to the uses, products and methods described in this section. Thus, in order to stabilize the quantity of CO₂ remaining trapped within said bituminous composition, the components and quantities as defined above, and/or the incorporation and/or storage conditions will advantageously be applied.

The examples below, with reference to the attached figures, illustrate the invention, but are in no way limiting.

### BRIEF DESCRIPTION OF THE DRAWINGS

FIG. 1 shows the evolution of the % CO₂ remaining in the sample (% by mass relative to the mass of the total composition at time t) as a function of the time elapsed after leaving the PAV (h), for compositions F3-1, F3-2, F3-3 and pure bitumen.

FIG. 2 shows the evolution of the mass of the bituminous compositions (g) as a function of the time elapsed after leaving the PAV (h), for compositions F3-1, F3-2, F3-3 and pure bitumen.

FIG. 3 shows the evolution of the phase angle (°) as a function of the complex shear modulus (Pa), for compositions F3-1 after incorporation of CO₂ and F3-1 as is.

FIG. 4 shows the evolution of the phase angle (°) as a function of the complex shear modulus (Pa), for compositions F3-1 after incorporation of CO₂ and F3-1 after ageing for 25 hours (v25 h).

FIG. 5 represents the evolution of the remaining CO₂ (% by mass relative to the mass of the bitumen base) as a function of the time elapsed after leaving the PAV (h), for the compositions of pure bitumen, F3-1, Dellite, Sepiolite, F3-2, F3-3 and F8, after incorporation of CO₂.

FIG. 6 represents the solid NMR sodium spectra of a bituminous composition according to the invention at a given time to, then at t0+8 months of storage at ambient temperature (25° C.), as well as the reference spectrum of NaHCO₃.

### EXAMPLES

### Part 1. Examples of Embodiment

Pure bitumen Type 35/50 according to EN 12591 from the Feyzin refinery, based on a conventional direct-route refining method, was modified by incorporating one or more additives and then trapping CO₂. In the case of composition F 3-1 presented in the examples below, another bitumen, also 35/50, (coming from the Brunsbüttel refinery) was used.

The adhesion promoter H1 was an amine additive: WETFIX BE from Akzo Nobel Surface Chemistry AB (CAS 68910-93-0).

Sodium hydroxide was supplied in the form of anhydrous pellets (CARL ROTH GMBH & Co. KG, Item No. 9356.1) and its purity was greater than 99%. The sodium hydroxide pellets were ground to a fine powder using an IKA® A11 mill (IKA-Werke Gmbh & Co) at 28,000 rpm for approximately 30 seconds, resulting in sodium hydroxide (NaOH) particles. Their mean maximum size measured on 20 particles using a microscope was approximately 50 μm.

The results presented were obtained under the following conditions:
the sodium hydroxide was introduced into the bitumen base already heated to 160° C.;
mixing temperature: 160° C.;
stirring speed: 400 rotations per minute (rpm);
stirring for 3 hours.

The adhesion promoter was then introduced in an amount of 0.2% by mass, relative to the mass of bitumen+NaOH+adhesion promoter.

Incorporation of CO₂ into the Bitumen

To incorporate CO₂ into bituminous compositions, a PAV device (model of the apparatus used: PAV3 from Applied Test Systems (ATS)) was used. This device is usually used to induce oxidation of bitumen, according to standard NF EN 14769. It simulates the long-term oxidative ageing of a bitumen composition, representing an oxidation of several years on the road. This test is usually carried out at a temperature of 100° C., at a pressure of 21 bar and for 20 hours using a compressed air cylinder. The bitumen is introduced into the device in cups, each containing 50 g of bitumen composition.

In the context of the invention, where incorporation of CO₂ into a bituminous composition is desired, instead of using a compressed air bottle as for the ageing tests, a pure CO₂ bottle (99%) was used and connected to the PAV device. The bitumen base, whether or not incorporating the selected additive(s), was placed for 20 hours at a temperature of 25° C. (unless otherwise specified in the examples below) under a pressure of 21.10³ hPa (21 bar) CO₂, so as to incorporate CO₂ into the bitumen composition. At the end of these 20 hours, the device was immediately returned to atmospheric pressure and the cups were immediately removed.

### Measurement of CO₂ Content in the Bitumen

The incorporated CO₂ content was measured by weighing, with a precision balance (Sartorius Practum 224-1S balance); the cups containing the bitumen before and after incorporation of CO₂ by the pressure ageing vessel PAV, as detailed below, were weighed. The measurements were carried out at 25° C. and under atmospheric pressure (1013.25 hPa). After PAV under air, there was no difference before and after PAV. After PAV under CO₂, the difference in mass obtained therefore corresponds to the mass of CO₂ incorporated in the bitumen.

### Stability Study of CO₂ Trapping

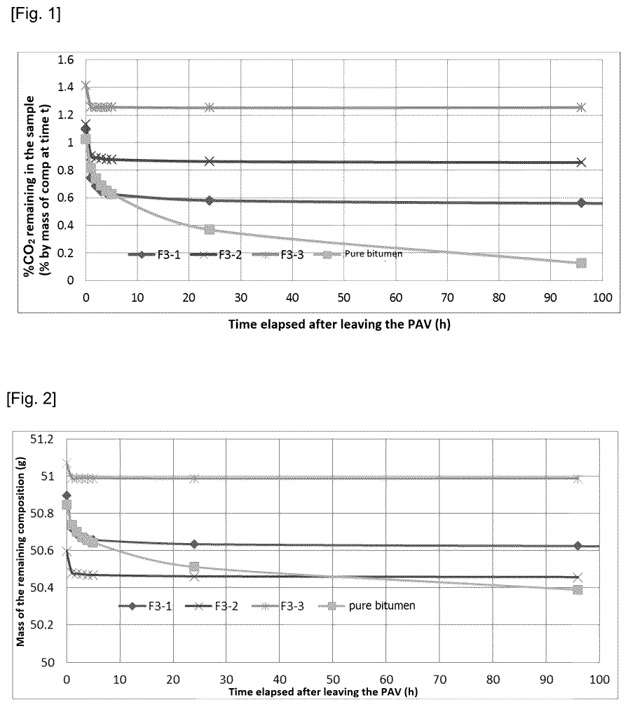

The stability of CO₂ trapping was evaluated after these 20 hours of PAV, while maintaining the bituminous composition obtained at room temperature (25° C.) and atmospheric pressure (1013.25 hPa). The results obtained are presented in Table 1 below and in FIG. 1. The times of 5 h, 24 h and 168 h correspond to the time elapsed, after the end of the CO₂ incorporation step, and therefore start as soon as the bituminous compositions studied leave the PAV device used for CO₂ incorporation.

In Table 1, the % NaOH and % CO₂ are % by mass of the quantity incorporated, given relative to the mass of the bitumen base used. The % CO₂ is obtained by weighing the samples before and after the PAV trapping step, and then over time. The relative % of CO₂ is the % of CO₂ still incorporated at a given time, with respect to the % of CO₂ incorporated on leaving the PAV. % variation t0 for the mass of the composition is the % variation obtained by comparing the mass of the composition at a given time and that on leaving the PAV. % variation 5 h for the mass of the composition is the % variation obtained by comparing the mass of the composition at a given time and that obtained after 5 h at 25° C. after leaving the PAV.

All the compositions presented in Table 1 were prepared with incorporation of the adhesion promoter, in an amount of 0.2% by mass, relative to the mass of bitumen+NaOH+adhesion promoter, which also corresponds to 0.2% by mass relative to the mass of bitumen alone.

In Table 1, the “% NaOH added” and the “% CO₂ incorporated on leaving the PAV” and the % CO₂ are given in % by mass relative to the mass of the bitumen base (more simply called pure bitumen in the table) or relative to the total mass of the bituminous composition (at the time indicated) including bitumen+NaOH+WETIX BE+CO₂ (more simply called composition or comp in the table). In the case of NaOH (as in the case of the WETIX bonding agent), if these % values given with two decimal places are the same, only one value is shown in the table. In Table 1, when the second digit after the decimal point, or even the last two digits after the decimal point, is 0, it is not mentioned.

The relative % CO₂ is the % CO₂ remaining relative to the % CO₂ incorporated on leaving the PAV.

TABLE 1

| | CO2 | | | | | | |
|---|---|---|---|---|---|---|---|
| | incorporation | | | Mass | Time at 25° C. after leaving the PAV. | | |
| | conditions | | | composition | After 5 h | | |
| | at 21 bar | | % CO2 on | on leaving | | | Mass (g) |
| % NaOH | Time | Duration | leaving | the PAV | relative | | composition |
| added | (° C.) | (h) | the PAV | (g)(*) | % CO2 | % CO2 | % variation t0 |
| 0 | 25 | 20 | 1.03% m pure | 50.8461 | 61% | 0.63% m | 50.6429 |
| pure bitumen | | | bitumen base | (=50.3259 + | | pure bitumen | 0.40% |
| (without | | | 1.02% m comp | 0.5202) | | 0.63% m | |
| addition of | | | | | | comp at 5 h | |
| NaOH) | | | | | | | |
| 0.5% m comp | 25 | 20 | 1.11% m pure | 50.8983 | 57% | 0.63% m | 50.6575 |
| (0.5% m pure | | | bitumen base | (=50.3411 + | | pure bitumen | 0.47% |
| bitumen) | | | 1.09% m comp | 0.5572) | | 0.62% m | |
| F 3-1 | | | | | | comp at 5 h | |
| 1% m comp | 25 | 20 | 1.16% m | 50.5988 | 77% | 0.89% m | 50.4688 |
| (1.01% m | | | pure bitumen | (=50.0266 + | | pure bitumen | 0.26% |
| pure bitumen) | | | 1.13% m comp | 0.5722) | | 0.88% m | |
| F 3-2 | | | | | | comp at 5 h | |
| 1.5% m comp | 25 | 20 | 1.45% m pure | 51.0707 | 89% | 1.29% m | 50.9899 |
| (1.53% m | | | bitumen base | (=50.3495 + | | pure bitumen | 0.16% |
| pure bitumen) | | | 1.41% m comp | 0.7212) | | 1.26% m | |
| F 3-3 | | | | | | comp at 5 h | |

| | Time at 25° C. after leaving the PAV. | | | | | |
|---|---|---|---|---|---|---|
| | After 24 h | | | After 96 h | | |
| | | | Mass (g) | | | Mass |
| | | | composition | | | composition |
| | relative | | % variation t0 | relative | | % variation t0 |
| % NaOH added | % CO2 | % CO2 | % variation 5 h | % CO2 | % CO2 | % variation 5 h |
| 0 | 36% | 0.37% m | 50.5121 | 12% | 0.13% m | 50.3892 |
| pure bitumen | | pure bitumen | 0.66% var t0 | | pure bitumen | 0.90% var t0 |
| (without | | 0.37% m | 0.26% var 5 h | | 0.13% m | 0.50% var 5 h |
| addition of | | comp at 24 h | | | comp at 96 h | |
| NaOH) | | | | | | |
| 0.5% m comp | 53% | 0.59% m | 50.6347 | 51% | 0.57% m | 50.6243 |
| (0.5% m pure | | pure bitumen | 0.52% var t0 | | pure bitumen | 0.54% var t0 |
| bitumen) | | 0.58% m | 0.04% var 5 h | | 0.56% m | 0.06% var 5 h |
| F 3-1 | | comp at 24 h | | | comp at 96 h | |
| 1% m comp | 76% | 0.88% m | 50.4518 | 75% | 0.87% m | 50.4575 |
| (1.01% m | | pure bitumen | 0.27% var t0 | | pure bitumen | 0.28% var t0 |
| pure bitumen) | | 0.86% m | <0.01% var 5 h | | 0.85% m | 0.02% var 5 h |
| F 3-2 | | comp at 24 h | | | comp at 96 h | |
| 1.5% m comp | 88% | 1.29% m | 50.9876 | / | / | / |
| (1.53% m | | pure bitumen | 0.16% var t0 | | | |
| pure bitumen) | | 1.25% m | <0.01% var 5 h | | | |
| F 3-3 | | comp at 24 h | | | | |

“/” not measured.
(*) in parentheses is mentioned the mass of the composition before incorporation of CO₂, then the mass of CO₂ incorporated, which is calculated by finding the difference using the mass of the composition measured on leaving the PAV.

FIG. 1 and FIG. 2 clearly demonstrate a stabilization of the mass of the bituminous compositions according to the invention, after a short period of CO₂ release (at most during the first 5 hours following the end of the PAV cycle used for trapping CO₂). In the absence of sodium hydroxide, the release of CO₂ continues over a much longer period. After 24 h at 25° C., the bitumen base not modified by the addition of sodium hydroxide only contains a quantity of CO₂ which represents 0.36% of the mass of CO₂ initially incorporated (relative %), whereas in the case of the compositions according to the invention, this quantity is always greater than 0.5%. Moreover, for bituminous composition F 3-1, weighing was also carried out after a storage period of 168 h at 25° C. after leaving the PAV. The relative % of CO₂ (i.e. the % of CO₂ remaining in relation to the % of CO₂ incorporated on leaving the PAV) was still 51%, which clearly shows the stabilization of the composition and retention of CO₂, after a quick first step of release lasting only a few hours.

Moreover, the release of CO₂ is reflected by a change in appearance of the bituminous composition, whose surface exhibits asperities and reliefs due to the degassing of CO₂.

From refinery to application, bitumen can be handled and stored hot at around 160° C. Therefore, hot desorption was also investigated for the composition F 3-1. For this, after approximately 100 hours of storage at 25° C., after the end of the CO₂ trapping step (the mass of the bituminous composition was therefore stabilized), a sample of this composition was placed in a microchamber for 1 hour at 160° C. The quantity of CO₂ released during the experiment was measured and corresponded only to about 10% of the mass of CO₂ trapped before this heating phase.

It has also been demonstrated that in the bituminous compositions according to the invention, at least a portion of the trapped CO₂ had reacted with the alkali hydroxide introduced and was therefore in the form of one or more CO₂/alkali hydroxide reaction products. FIG. 6 represents the solid sodium NMR spectra of composition F 3-3 according to the invention at a given time t0 situated after the release phase for 24 hours, then at t0+8 months of storage at room temperature (25° C.), as well as the reference spectrum of NaHCO₃. The spectra are obtained by nuclear magnetic resonance of the ²³Na nucleus on a 300 MHZ spectrometer, on solid samples spun at the magic angle at a frequency of 8 kHz, by direct pulse with heteronuclear decoupling of the ¹H nuclei. 256 scans were acquired for each spectrum.

The spectrum obtained demonstrates the presence of an intense peak corresponding to NaHCO₃. There are no other visible peaks, and there is especially no peak that would correspond to NaOH.

### Evaluation of Bituminous Compositions

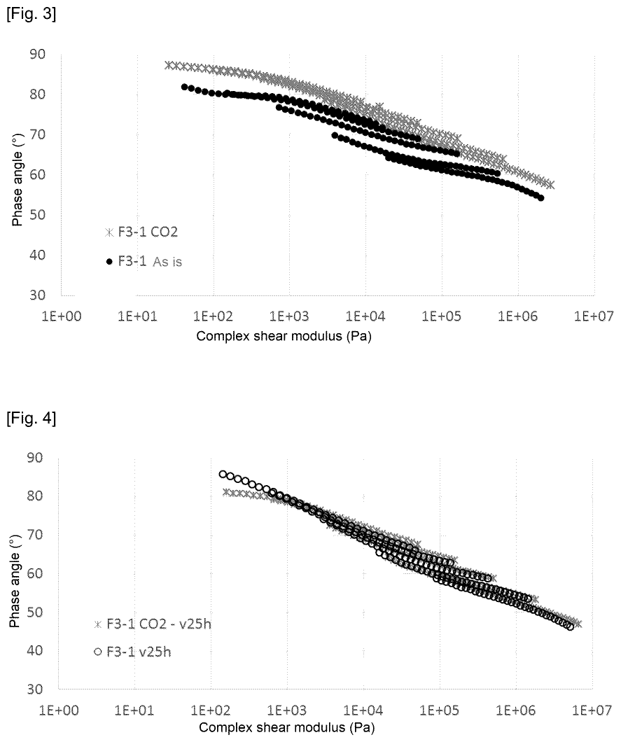

Bituminous compositions were evaluated, while their mass had stabilized at 25° C. The following evaluations were performed by:
measuring needle penetrability (Pene) at 25° C., according to EN 1426, the results being expressed in 1/10 mm;
measuring the ring and ball softening point (RBSP), according to EN 1427, the results being expressed in ° C.;
assessing the resistance to ageing; such measurements were also carried out after accelerated long-term ageing in a pressure ageing vessel (PAV), operating at 100° C. and 21 MPa of air pressure. The ageing period used was 25 hours. The results are presented in Table 2 below;
the rheological characterizations were carried out using a dynamic shear rheometer Kinexus Model Lab+ from Malvern. The tests were conducted using 20 mm plane/plane geometries. The results were obtained by carrying out frequency sweeps in the linear range at 70° C. Two types of characterizations were carried out: determining the complex shear modulus (in Pa) by varying the angular frequency i) with a temperature sweep of 30 to 70° C. (FIG. 3); ii) with a frequency sweep of 0.1 rad/s to 100 rad/s (FIG. 4).

TABLE 2

| | | After PAV aging |
|---|---|---|
| Bituminous base | As is | (2) |
| Penetrability at 25° C. | 41 | 18 |
| ( 1/10 mm) | | |
| RBSP (° C.) | 54.6 | 70 |
| Δ (RBSP) (° C.) | 15.4 | |

| | | | | With CO2 (1) |
|---|---|---|---|---|
| | without | After PAV | With CO2 | After PAV |
| F3-1 | CO2 | aging (2) | (1) | aging (2) |
| Penetrability at 25° C. | 41 | 33 | 52 | 35 |
| ( 1/10 mm) | | | | |
| RBSP (° C.) | 58 | 66.4 | 53.2 | 63.4 |
| Δ(RBSP) (° C.) | 8.4 | | 10.2 | |

(1) CO₂ incorporation (20 h - 25° C. - 21 bar)
(2) PAV ageing (25 h - 100° C. - 21 bar)

These results show that the trapping of CO₂ within the bituminous composition leads to both an increase in penetrability and a decrease in the RBSP. Moreover, in the case of the compositions according to the invention, it appears that the variation in penetrability and RBSP, after PAV ageing, remains greatly reduced, compared with what is observed for the bitumen base alone. Thus, the benefit of the use of the alkali hydroxide and adhesion promoter is maintained: The composition has a better resistance to ageing than the bitumen base.

The analyses presented in FIG. 3 and FIG. 4 show that the introduction of CO₂ makes it possible to lower the viscosity of the bituminous composition. Thus, the compositions according to the invention will be able to be used at lower temperatures than those conventionally used, for example for the preparation of hot mixes. Moreover, the trapping of CO₂ does not alter the oxidation resistance properties of the bituminous compositions obtained in the context of the invention.

### Modulation of CO₂ Incorporation Conditions

Other tests were carried out by modifying the duration and/or the temperature of the CO₂ trapping step in the PAV chamber under 21 bar.

The results presented in Table 3 were obtained. They show that the quantity of CO₂ trapped at the start can be modulated by the choice of parameters used during the trapping step.

In Table 3, the % NaOH and % CO₂ are % by mass of the quantity incorporated, given relative to the mass of the bitumen base used. The % CO₂ is obtained by weighing the samples before and after the PAV trapping step, and then over time. The relative % of CO₂ is the % of CO₂ still incorporated at a given time, with respect to the % of CO₂ incorporated on leaving the PAV. % variation t0 for the mass of the composition is the % variation obtained by comparing the mass of the composition at a given time and that on leaving the PAV. % variation 5 h for the mass of the composition is the % variation obtained by comparing the mass of the composition at a given time and that obtained after 5 h at 25° C. after leaving the PAV.

All the compositions presented in Table 3 were prepared with incorporation of the adhesion promoter, in an amount of 0.2% by mass, relative to the bitumen mass.

It appears that bituminous compositions for which CO₂ incorporation is carried out at 25° C. have a greater quantity of CO₂ incorporated, and, furthermore, that incorporation is more stable over time. It also appears that the incorporation of CO₂ increases with the quantity of sodium hydroxide incorporated in the bituminous composition.

TABLE 3

| | | |
|---|---|---|
| CO2 | | |
| incorporation | Mass | Time at 25° C. after leaving the PAV. |
| conditions | composition | After 5 h (or 4 if specified) |

| | at 21 bar | | CO2 on | on leaving | | | Mass (g) |
|---|---|---|---|---|---|---|---|
| % NaOH | Time | Duration | leaving | the PAV | relative | | composition |
| added | (° C.) | (h) | the PAV | (g)(*) | % CO2 | % CO2 | % variation t0 |
| 0 | 25 | 72 | 1.44% m | 50.7592 | 0.9% | 0.1% m | 50.0465 |
| | | | pure bitumen | (=50.04 + | | pure bitumen | 1.40% |
| | | | 1.42% comp | 0.7192) | | 0.1% m | |
| | | | at t0 | | | comp at t0 | |
| 0.5 | 25 | 72 | 0.90% m | 50.3516 | 64% | 0.58% m | 50.1931 |
| | | | pure bitumen | (=49.9071 + | | pure bitumen | 0.31% |
| | | | 0.88% comp | 0.4445) | | 0.57% m | |
| | | | at t0 | | | comp at 5 h | |
| 1 | 25 | 72 | 1.28% m | 50.6311 | 84% | 1.07% m | 50.5286 |
| | | | pure bitumen | (=50 + | | pure bitumen | 0.20% |
| | | | 1.25% comp | 0.6311) | | 1.05% m | |
| | | | at t0 | | | comp at 5 h | |
| 1.5 | 25 | 72 | 1.67% m | 50.8186 | 92% | 1.54% m | 50.7564 |
| | | | pure bitumen | (=50 + | | pure bitumen | 0.14% |
| | | | 1.61% comp | 08186) | | 1.5% m | |
| | | | at t0 | | | comp at 5 h | |

| Time at 25° C. after leaving the PAV. | |
|---|---|
| After 24 h | After 96 h |

| | | | Mass (g) | | | Mass (g) |
|---|---|---|---|---|---|---|
| | | | composition | | | composition |
| % NaOH | relative | | % variation t0 | relative | | % variation t0 |
| added | % CO2 | % CO2 | % variation 5 h | % CO2 | % CO2 | % variation 5 h |
| 0 | / | / | / | / | / | / |
| 0.5 | 59% | 0.53% m | 50.1713 | 53% | 0.48% m | 50.1445 |
| | | pure bitumen | 0.36% var t0 | | pure bitumen | 0.41% var t0 |
| | | 0.53% m | 0.04% var 5 h | | 0.47% m | 0.1% var 5 h |
| | | comp at 24 h | | | comp at 96 h | |
| 1 | 82% | 1.05% m | 50.5206 | / | / | / |
| | | pure bitumen | 0.22% var t0 | | | |
| | | 1.03% m | 0.02% var 5 h | | | |
| | | comp at 24 h | | | | |
| 1.5 | 92% | 1.53% m | 50.7498 | / | / | / |
| | | pure bitumen | 0.14% var t0 | | | |
| | | 1.48% m | 0.01% var 5 h | | | |
| | | comp at 24 h | | | | |

| | CO2 | | | | | | |
|---|---|---|---|---|---|---|---|
| | incorporation | | | Mass | Time at 25° C. after leaving the PAV. | | |
| | conditions | | | composition | After 5 h (or 4 if specified) | | |
| | at 21 bar | | % CO2 on | on leaving | | | Mass (g) |
| % NaOH | Time | Duration | leaving | the PAV | relative | | composition |
| added | (° C.) | (h) | the PAV | (g)(*) | % CO2 | % CO2 | % variation t0 |
| 0 | 25 | 20 | 1.03% m | 50.8461 | 61% | 0.63% m | 50.6429 |
| | | | pure bitumen | (=50.3259 + | | pure bitumen | 0.40% |
| | | | 1.02% comp | 0.6202) | | 0.63% comp | |
| | | | at t0 | | | at 5 h | |
| 0.5 | 25 | 20 | 1.11% m | 50.8983 | 57% | 0.63% m | 50.6575 |
| | | | pure bitumen | (=50.3411 + | | pure bitumen | 0.47% |
| | | | 1.09% comp | 0.5672) | | 0.62% comp | |
| | | | at t0 | | | at 5 h | |
| 1 | 25 | 20 | 1.14% m | 50.5988 | 77% | 0.89% m | 50.4688 |
| | | | pure bitumen | (=50.0266 + | | pure bitumen | 0.26% |
| | | | 1.13% comp | 0.5722) | | 0.88% comp | |
| | | | at t0 | | | at 5 h | |
| 1.5 | 25 | 20 | 1.43% m | 51.0707 | 89% | 1.29% m | 50.9899 |
| | | | pure bitumen | (=50.3495 + | | pure bitumen | 0.16% |
| | | | 1.41% comp | 0.7212) | | 1.26% comp | |
| | | | at t0 | | | at 5 h | |
| 0 | 25 | 1 | 0.2% m | 50.2081 | 48% | 0.1% m | 4 h: 50.1551 |
| | | | pure bitumen | (=50.1086 + | (4 h) | pure bitumen | 0.11% var t0 |
| | | | 0.2% comp | 0.1015) | | 0.1% comp | |
| | | | at t0 | | | at 4 h | |
| 0.5 | 25 | 1 | 0.2% m | 49.9457 | 71% | 0.143% m | 4 h: 49.9166 |
| | | | pure bitumen | (=49.8456 + | (4 h) | pure bitumen | 0.06% var t0 |
| | | | 0.2% comp | 0.1001) | | 0.142% comp | |
| | | | at t0 | | | at 4 h | |
| 1 | 25 | 1 | 0.31% m | 50.2638 | 93% | 0.29% m | 4 h: 50.2524 |
| | | | pure bitumen | (=50.1108 + | (4 h) | pure bitumen | 0.02% var t0 |
| | | | 0.3% comp | 0.153) | | 0.28% comp | |
| | | | at t0 | | | at 4 h | |
| 1.5 | 25 | 1 | 0.39% m | 53.3303 | 92% | 0.36% m | 4 h: 53.3148 |
| | | | pure bitumen | (=53.1281 + | (4 h) | pure bitumen | 0.03% var t0 |
| | | | 0.38% comp | 0.2022) | | 0.35% comp | |
| | | | at t0 | | | at 4 h | |
| 0.5 | 120 | 20 | 0.69% m | 50.6191 | 73 | 0.5% m | 4 h: 50.5248 |
| | | | pure bitumen | (=50.2742 + | (4 h) | pure bitumen | 0.19% var t0 |
| | | | 0.68% comp | 0.3449) | | 0.5% comp | |
| | | | at t0 | | | at 4 h | |

| | Time at 25° C. after leaving the PAV. | | | | | |
|---|---|---|---|---|---|---|
| | After 24 h | | | After 96 h | | |
| | | | Mass (g) | | | Mass (g) |
| | | | composition | | | composition |
| % NaOH | relative | | % variation t0 | relative | | % variation t0 |
| added | % CO2 | % CO2 | % variation 5 h | % CO2 | % CO2 | % variation 5 h |
| 0 | 36% | 0.37% m | 50.5121 | 12% | 0.13% m | 50.3892 |
| | | pure bitumen | 0.66% var t0 | | pure bitumen | 0.9% var t0 |
| | | 0.37% comp | 0.26% var 5 h | | 0.13% comp | 0.5% var 5 h |
| | | at 24 h | | | at 96 h | |
| 0.5 | 53% | 0.59% m | 50.6347 | 51% | 0.57% m | 50.6243 |
| | | pure bitumen | 0.52% var t0 | | pure bitumen | 0.54% var t0 |
| | | 0.58% comp | 0.05% var 5 h | | 0.56% comp | 0.07% var 5 h |
| | | at 24 h | | | at 96 h | |
| 1 | 76% | 0.88% m | 50.4518 | 75% | 0.87% m | 50.4575 |
| | | pure bitumen | 0.27% var t0 | | pure bitumen | 0.28% var t0 |
| | | 0.86% comp | 0.01% var 5 h | | 0.85% comp | 0.02% var 5 h |
| | | at 24 h | | | at 96 h | |
| 1.5 | 88% | 1.29% m | 50.9876 | / | / | / |
| | | pure bitumen | 0.16% var t0 | | | |
| | | 1.25% comp | <0.01% var 5 h | | | |
| | | at 24 h | | | | |
| 0 | 25% | 0.05% m | 50.1316 | / | / | / |
| | | pure bitumen | 0.15% var t0 | | | |
| | | 0.05% comp | 0.05% var 4 h | | | |
| | | at 24 h | | | | |
| 0.5 | 72% | 0.146% m | 49.918 | / | / | / |
| | | pure bitumen | 0.06% var t0 | | | |
| | | 0.145% comp | <0.01% var 4 h | | | |
| | | at 24 h | | | | |
| 1 | 90% | 0.28% m | 50.2489 | / | / | / |
| | | pure bitumen | 0.03% var t0 | | | |
| | | 0.27% comp | <0.01% var 4 h | | | |
| | | at 24 h | | | | |
| 1.5 | 90% | 0.35% m | 53.3092 | / | / | / |
| | | pure bitumen | 0.04% var t0 | | | |
| | | 0.34% comp | 0.01% var 4 h | | | |
| | | at 24 h | | | | |
| 0.5 | 64% | 0.44% m | 50.494 | / | / | / |
| | | pure bitumen | 0.25% var t0 | | | |
| | | 0.44% comp | 0.06% var 4 h | | | |
| | | at 24 h | | | | |

“/” not measured.
(*) in parentheses is mentioned the mass of the composition before incorporation of CO₂, then the mass of CO₂ incorporated, which is calculated by finding the difference using the mass of the composition measured on leaving the PAV.

### Comparative Tests

By way of comparison, other bituminous compositions modified with an additive other than an alkali hydroxide were subjected to the same CO₂ trapping step. The results presented were obtained under the following conditions:
the selected additive was introduced into the bitumen base already heated to 160° C.;
mixing temperature: 160° C.;
stirring speed: 200 rpm;
stirring for 30 minutes;
the quantity of additive was 3.0% m/m relative to the total mass of the bituminous composition obtained, corresponding to 3.1% m/m relative to the mass of the bitumen base.

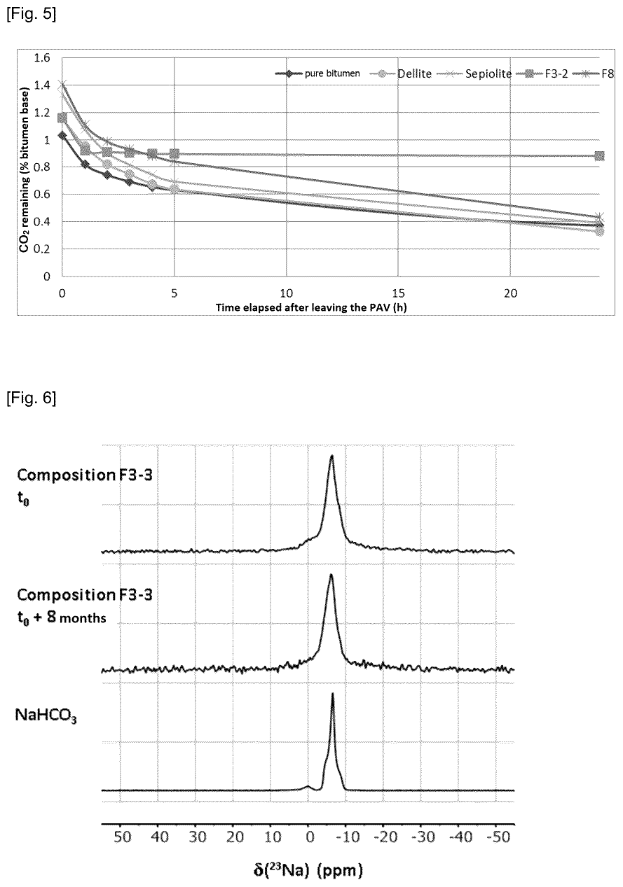

The results obtained, on bituminous compositions 24 h after the CO₂ trapping step under PAV, are presented in Table 4 and FIG. 5. They show that none of the other additives leads to a stabilized trapping of a portion of the CO₂, after a first release phase, contrary to what is obtained with sodium hydroxide.

TABLE 4

| | | F3-2 | | | |
|---|---|---|---|---|---|
| | | Sodium | | | |
| Bituminous | Bitumen | hydroxide + | F8 | Clay | |
| composition name | base | adhesion | Surfactant | (Dellite | Clay |
| Type of additive | / | promotor | (a) | 67 g) | (Sepiolite) |
| Penetrability | 41 | 69 | 67 | 40 | 40 |
| ( 1/10 mm) | | | | | |
| RBSP (° C.) | 51.8 | 48.2 | 48.1 | 55.6 | 52.5 |
| CO2 incorporated on | 1.03 | 1.16 | 1.40 | 1.15 | 1.33 |
| leaving the PAV % m/m | | | | | |
| relative to the | | | | | |
| bitumen base | | | | | |
| CO2 remaining after 5 h | 0.63 | 0.89 | 0.84 | 0.64 | 0.69 |
| at 25° C. m/m relative | | | | | |
| to the bitumen base | | | | | |
| CO2 remaining after 24 h | 0.37 | 0.88 | 0.43 | 0.33 | 0.39 |
| at 25° C. m/m relative | | | | | |
| to the bitumen base | | | | | |

### (A) Amine (PIBA03)

1. A bituminous composition comprising:
a bitumen base modified by the incorporation of an alkali hydroxide, the bitumen base representing at least 72% by mass of said bituminous composition,
wherein CO₂ is trapped in said bituminous composition and represents from 0.5 to 5% by mass, preferably from 0.5 to 4% by mass, and preferentially from 0.5 to 3% by mass, even more preferably from 0.5 to 2% or from 0.5 to 1.5% or from 0.7 to 2% by mass of the mass of the bitumen base and the mass of the bituminous composition is stable at 25° C. and under 1013.25 hPa, over a period Ps of at least 10 hours, preferably at least 15 hours.

2. The bituminous composition according to claim 1, wherein the CO₂ was trapped in the bituminous composition following a trapping step, especially carried out by placing said bitumen base modified by incorporation of an alkali hydroxide into a CO₂ pressure vessel, followed by a step of releasing a portion of the trapped CO₂ until the mass of the bituminous composition obtained stabilizes, this stabilization especially taking place 3 hours or more after the end of the trapping step, especially 5 to 10 hours after the end of the trapping step.

3. The bituminous composition according to claim 1, wherein the bitumen base has been modified by incorporating from 0.1 to 9% by mass, preferably from 0.2 to 4.5% by mass, and preferentially from 0.2 to 2% by mass of alkali hydroxide, relative to the mass of the bitumen base.

4. The bituminous composition according to claim 1, wherein the trapped CO₂ is present, at least in part, in the bituminous composition in the form of one or more reaction products with alkali hydroxide.

5. The bituminous composition according to claim 1, wherein the alkali hydroxide is NaOH or KOH.

6. The bituminous composition according to claim 1, wherein the alkali hydroxide is NaOH, and at least a portion of the incorporated NaOH, or even all of the incorporated NaOH, has reacted with the trapped CO₂ and is present in the bituminous composition in the form of one or more products of the reaction between CO₂ and NaOH, especially in the form of NaHCO₃ and Na₂CO₃, or exclusively in the form of NaHCO₃.

7. The bituminous composition according to claim 1, wherein the alkali hydroxide is KOH, and at least a portion of the incorporated KOH, or even all of the incorporated KOH, has reacted with the trapped CO₂ and is present in the bituminous composition as one or more products of the reaction between CO₂ and KOH, especially in the form of KHCO₃ and K₂CO₃, or exclusively in the form of KHCO₃.

8. The bituminous composition according to claim 1, wherein the bitumen base represents at least 83% by mass and preferentially at least 89% by mass of the total mass of the bituminous composition.

9. The bituminous composition according to claim 1, further comprising an adhesion promoter chosen from amines, diamines, polyamines, alkyl amidoamines, amidopolyamines, imidazolines, and mixtures thereof, said adhesion promoter preferably representing 0.01 to 2.5% by mass, preferentially 0.05 to 1.1% by mass, and even more preferably 0.1 to 0.4% by mass, of the mass of the bitumen base.

10. The bituminous composition according to claim 1, further comprising one or more polymers chosen from olefin polymers and elastomers, especially from cross-linked or cross-linkable elastomers, preferably representing from 0.1 to 12% by mass, preferentially from 0.3 to 10% by mass, and even more preferably from 0.5 to 7% by mass, of the mass of the bitumen base.

11. A preparation method of a bituminous composition comprising a bitumen base representing at least 72% by mass of said bituminous composition, said method comprising the following successive steps:
a) obtaining a modified bitumen base, comprising the incorporation of an alkali hydroxide into a bitumen base, said incorporation being followed by or accompanied by mixing, preferably under heating at a temperature in the range from 90 to 230° C., preferably in the range from 120 to 200° C., and preferentially in the range from 120 to 180° C.,
b) trapping CO₂ in the modified bitumen base at a mass content especially representing from 0.8 to 5.8% by mass, preferably from 0.8 to 4.5% by mass, preferentially from 0.8 to 3.5% by mass, and even more preferentially from 0.8 to 2.6% by mass, or from 0.8 to 1.8% by mass of the mass of the bitumen base.

12. The preparation method according to claim 11, wherein the CO₂ is incorporated by placing the modified bitumen base in a vessel under CO₂ pressure, the vessel being maintained at a temperature ranging from 10 to 200° C., preferably ranging from 20 to 160° C., and preferentially ranging from 25 to 160° C., or even 80 to 160° C., the CO₂ pressure being especially chosen in the range from 5.10³ to 8.10⁴ hPa, preferably in the range from 5.10³ to 5.10⁴ hPa, and preferentially in the range from 1.10⁴ to 3.10⁴ hPa.

13. The preparation method according to claim 11, wherein in step a), the mass of alkali hydroxide incorporated represents from 0.1 to 9% by mass, preferably from 0.2 to 4.5%, and preferentially from 0.2 to 2% by mass, of the mass of the bitumen base.

14. The preparation method according to claim 11, wherein the alkali hydroxide is NaOH or KOH.

15. The preparation method according to claim 11, wherein during step a), an adhesion promoter chosen from amines, diamines, polyamines, alkyl amidoamines, amidopolyamines, imidazolines, and mixtures thereof, is also incorporated into the bitumen base, said adhesion promoter preferably being introduced in a proportion of 0.01 to 2.5% by mass, preferentially 0.05 to 1.1% by mass, and even more preferably 0.1 to 0.4% by mass, of the total mass of the bitumen base.

16. The preparation method according to claim 11, wherein during step a), one or more polymers chosen from olefin polymers and elastomers, especially from cross-linkable elastomers, are also incorporated into the bitumen base, said polymer(s) preferably being introduced in a proportion preferably of 0.1 to 12% by mass, preferably of 0.3 to 10% and preferentially of 0.5 to 7% by mass, of the mass of the bitumen base.

17. The preparation method according to claim 11, wherein the bituminous composition resulting from step b) is subjected to a step of releasing a portion of the trapped CO₂, at the end of which the mass of the bituminous composition is stable.

18. The method according to claim 17, wherein the releasing step leads to a quantity of CO₂ trapped in the bituminous composition, corresponding to 0.5 to 5% by mass, preferably to 0.5 to 4% by mass, and preferentially to 0.5 to 3% by mass, and even more preferably 0.5 to 2% or 0.5 to 1.5% or 0.7 to 2% by mass, relative to the mass of the bitumen base.

19. A method for preparing a waterproofing coating, a membrane or an impregnation layer with a bituminous composition according to claim 1.

20. A method for preparing a surface coating, a hot mix, a cold mix, a cold cast mix, an emulsion gravel or a roadway surface, comprising combining a bituminous composition according to claim 1 with aggregates and/or recycled millings.

21. A method for preparing a bituminous mix, comprising hot mixing a bituminous composition according to claim 1 with aggregates and/or recycled millings, and, optionally, mineral and/or synthetic fillers.

22. A mix comprising a bituminous composition according to claim 1 in mixture with aggregates and/or recycled millings, and, optionally, mineral and/or synthetic fillers.

23. A method for preparing an asphalt, comprising hot mixing a bituminous composition according to claim 1 with mineral and/or synthetic fillers.

24. The method according to claim 23, wherein hot mixing with the bituminous composition can be carried out at a temperature of 80 to 200° C., preferably 80 to 180° C. and preferentially 100 to 160° C.

25. An asphalt comprising a bituminous composition according to claim 1 in mixture with mineral and/or synthetic fillers.

26. A method for stabilizing the quantity of CO₂ trapped within a bituminous composition, comprising incorporating the CO₂ in said bituminous composition, followed by incorporating an alkali hydroxide.
